(19) United States
(12) Patent Application Publication
(10) Pub. No.: US 2009/0289570 A1
(43) Pub. Date: Nov. 26, 2009

(54) METHOD FOR SUPPLYING A GAS DISCHARGE LAMP, AND A BALLAST CIRCUIT FOR SUCH LAMP

(75) Inventor: Ronald Hans Van Der Voort, Oss (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 11/721,441

(22) PCT Filed: Dec. 6, 2005
(86) PCT No.: PCT/IB2005/054083

§ 371 Date: Jun. 12, 2007

(30) Foreign Application Priority Data
Dec. 14, 2004 (EP) 04106561.6

(51) Int. Cl. H05B 41/24

(52) U.S. Cl. 315/247

(57) ABSTRACT

A method and a ballast circuit to supply a gas discharge lamp by a high frequency voltage, which, by using a voltage controlled first generator (4), is generated from a substantial sinusoidal mains voltage of a lower mains frequency provided by a main source. A control loop is used which comprises a second generator (10) for providing a reference waveform signal having a frequency of and being synchronized with a supply voltage. The reference signal is compared with a measurement current signal (im), which is representative for a supply current to the lamp, to provide an error signal. The error signal modulates the frequency of the high frequency voltage such that the error signal is minimized.

### FIELD OF THE INVENTION

The invention relates to a method for supplying a gas discharge lamp and to a ballast circuit for such lamp as described in the preambles of claim 1 and claim 5, respectively.

### BACKGROUND OF THE INVENTION

A method and a ballast circuit of said type are disclosed by U.S. Pat. No. 6,483,252. With the prior method and ballast circuit rectifying of the mains voltage includes buffering of the rectified voltage by using a buffer capacitor. A ripple voltage still present on the rectified voltage is detected and used as the modulating signal for the voltage-controlled generator, which controls the inverter. The frequency of the ripple voltage is twice that of the mains voltage. The ripple signal has a sawtooth waveform and it will show a phase shift with respect to the mains current. The control signal to switches of the inverter is modulated by said modulation signal to prevent the occurrence of acoustic resonance near an acoustic resonant frequency which may make the operation of the lamp audible and which may damage the ballast circuit, the lamp inclusive. This is in particular the case with ballast circuits with high intensity discharge (HID) lamps.

A single-stage ballast circuits does not have a large buffer capacitor in its rectifying part. Therefore, after rectifying of the mains voltage by a full bridge rectifier, the resulting voltage is not constant. Further, with a mains voltage and mains current being sinusoidal and in phase, a power supplied by the mains has a sinusoidal waveform of twice the mains frequency with valleys to zero value at every zero crossing of the mains voltage. As a consequence, high frequency output power supplied by an inverter tends to have an envelope waveform which is similar to the waveform of the mains input power. Because of the operation of the circuit as a whole, the inverter may not be able to provide a sufficient power to maintain said waveform. As a consequence the envelope of the high frequency power will not have a sinusoidal waveform. In turn this will be reflected to the mains input side of the circuit as a whole, meaning that unwanted harmonics of the mains frequency will occur in the mains current. A total harmonic distortion (THD) factor at the mains side will then exceed standards. This must be avoided but it could not be attained by the prior art method and circuit.

### OBJECT OF THE INVENTION

It is therefore an object of the invention to solve the drawbacks of the prior art as described above.

### SUMMARY OF THE INVENTION

The above object of the invention is achieved by providing a method as described in claim 1.

The method as a whole or in part can be realized by the use of software. By using software the size and the costs of the ballast circuit are low with respect to the prior art. The size and costs are virtually independent from power requirements.

The above object of the invention is also achieved by providing a ballast circuit as described in claim 8.

### BRIEF DESCRIPTION OF THE DRAWINGS

The invention will become more gradually apparent from the following exemplary description in connection with the accompanying drawing. In the drawings:

FIG. 1 shows a diagram of a first embodiment of a control part of a ballast circuit according to the invention for illustrating a first example of the method according to the invention;

FIG. 2 shows a diagram of a second embodiment of a control part of a ballast circuit according to the invention for illustrating a second example of the method according to the invention; and

FIG. 3 shows a diagram of a third embodiment of a control part of a ballast circuit according to the invention for illustrating a third example of the method according to the invention.

### DETAILED DESCRIPTION OF EXAMPLES

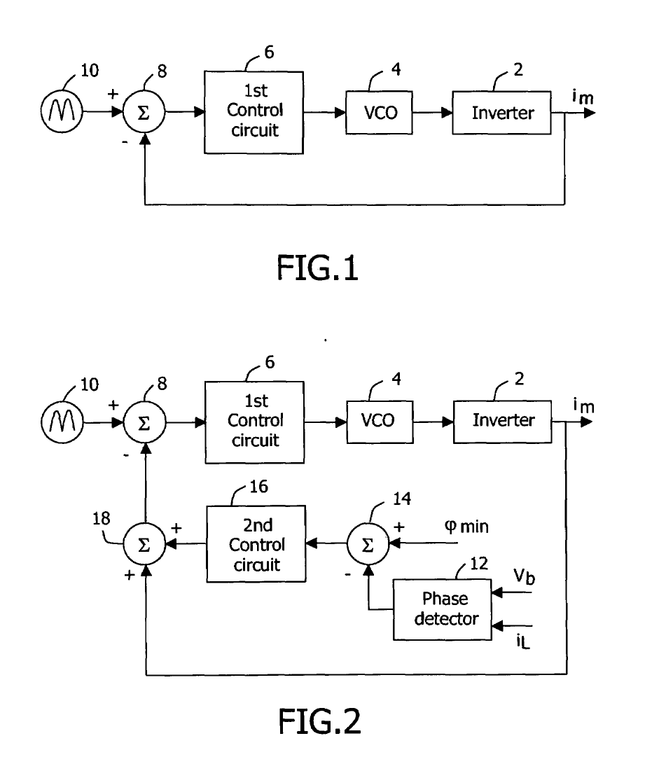

The diagram of a first embodiment of a control part of a ballast circuit according to the invention shown in FIG. 1 comprises an inverter 2, a voltage controlled generator (VCO) 4 and a first control circuit 6. The inverter 2 can be a full-bridge or half-bridge inverter of which switches (not shown) are connected in series between a rectified, substantially unbuffered voltage, which is supplied by a rectifier (not shown) by rectifying a substantial sinusoidal mains voltage supplied by a main source (not shown). A waveform of the rectified voltage will consist of a succession of rectified half cycles of the mains waveform. The switches are switched on and off alternately by having generator 4 supply complementary control signals to inputs of the switches. This will result in the generation of a substantially rectangular voltage at a node between said switches. Through this specification said substantially rectangular voltage is called also bridge output voltage. Said node is connected to a gas discharge lamp (not shown) by a tank circuit (not shown), which comprises one or more inductors and one or more capacitors. In general the tank circuit is tuned to a frequency of the bridge output voltage. Said frequency is much higher, possibly in a range of 50 kHz to 300 kHz, than the mains frequency of, in general, 50 Hz or 60 Hz.

To this point of the description of FIG. 1 the diagram is in accordance with prior art ballast circuits for a gas discharge lamp. Because this part of the diagram is well known to a person skilled in this art some physical parts like the rectifier, the bridge, the tank circuit and the lamp are not shown in the drawings.

The first control circuit 6 is connected to a control input of the generator 4. Dependent on an amplitude of a control signal supplied by the control circuit 6 to the generator 4, the generator changes the frequency at which it oscillates. In general such control is used to provide proper conditions to ignite the lamp and to re-ignite the lamp again when passing a zero crossing of the mains voltage.

Ideally, the input power at the mains input side has a waveform which is sinusoidal and which has a frequency of twice the mains frequency. That is, in an ideal situation where the mains voltage and mains current are in phase and/or the inverter can provide high frequency output power having an envelope waveform which is identical to that at the mains input side, low frequency inclusive. Until now such situation could not be attained. As a result, said high frequency power envelope waveform was not sinusoidal, which in turn was reflected to the waveform of the mains current, causing harmonics of the low mains frequency in the mains current which exceeded standards for a total harmonic distortion (THD) factor.

According to the invention the THD factor is reduced by shaping the waveform of the mains current to substantially a sinusoidal waveform.

To this end, the mains current is measured to provide a mains current measurement signal iₘ, which is compared with or subtracted from a reference waveform signal by a subtractor (or comparator) 8. The reference waveform signal is generated by a second generator 10.

What waveform shape is to be used for the reference waveform signal is dependent on the location at which the mains current itself or a representation thereof is measured. As explained hereinafter, the shape of the reference waveform signal need not to be such that the mains current becomes perfectly sinusoidal. If the mains current is truly measured at the mains input side the waveform of the reference waveform signal will be chosen to be substantially sinusoidal and will have the mains frequency. If the a representation of the mains current is measured at the output of the full bridge rectifier said waveform will consist of a succession of half cycles of the mains waveform with identical polarities. The reference waveform signal is synchronized on a representation of the mains voltage to have identical phases.

The subtractor 8 provides at its output an error signal which is supplied to the first control circuit 6. The first control circuit may be an integrating (I) or a proportional-integrating (PI) controller. With proper loop amplification to avoid loop oscillation, the control loop of FIG. 1 will control the voltage controlled generator 4 and thereby the impedance of the ballast circuit such that the waveform of the mains current measurement signal iₘ will follow and match the reference waveform signal with identical phases with an error signal supplied by subtractor 8 approaching zero. As a result the mains current will be substantially void of unwanted low frequency harmonics, with the THD factor at the mains side being remarkably reduced.

The diagram of the second embodiment of a control part of a ballast circuit according to the invention shown in FIG. 2 differs from the first embodiment of FIG. 1 in that it further comprises means to have the ballast circuit always operate in an inductive mode. To that extend the diagram of FIG. 2 further comprises means to measure the bridge output voltage V_{b}, means for measuring the current i_{L} through the inductor of the tank circuit connected to the lamp and a phase detector 12 to detect a phase difference of the phase of the measured bridge output voltage V_{b} with respect to the phase of the inductor current i_{L}. It is observed that the bridge output voltage V_{b} will always lead the inductor current i_{L}. Assuming said phase difference, or the output of phase detector 12, being positive, said phase difference is subtracted from (or compared to) a reference minimum phase difference φₘᵢₙ by a second subtractor 14, which will provide a second error signal accordingly. The second error signal is supplied to a second control circuit 16, which may be an integrating (I) or a proportional-integrating (PI) controller. An output signal from the second control circuit 16 is supplied to an adder 18, which also receives the mains current measurement signal iₘ to provide their sum to the subtracting input of the first subtractor 8 instead of the mains current measurement signal iₘ only. As a result of the use of the different feedback signal (with respect to the diagram of FIG. 1) to the subtracting input of the first subtractor 8 the first control circuit 6 responds as if the mains current is larger than it really is and the control loop will keep on trying to increase the high frequency. The high frequency will not decrease below a minimum frequency because a still lower frequency would decrease the phase difference between Vb and i_{L} beyond φₘᵢₙ. The tank circuit and the ballast circuit as a whole will operate in inductive mode only.

The reason for using the additional part containing the phase detector 12 to adder 18 of FIG. 2 is that, without such additional part, under circumstances the wanted output power envelope waveform cannot follow the desired mains power waveform. As a result the control loop (without said additional part) keeps on decreasing the high frequency, so that a capacitive mode of operation of the circuit as a whole is entered. A capacitive mode of operation is unwanted because it may result in extensive switching losses or even circuit failure as a result of a to high dv/dt across the inverter switches, which are usually MOSFETs.

Said additional part of FIG. 2 with respect to FIG. 1 can be arranged differently and/or at a different location with the same effect. For example the adder 18 can be replaced by a subtractor, which is arranged at the positive input or at the output of subtractor 8, with the negative input of the substitute subtractor being connected to the output of the second control circuit 16.

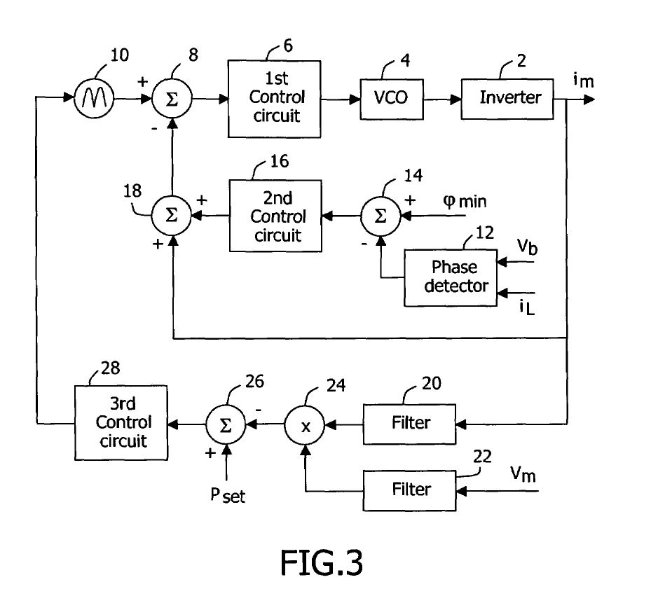

The diagram of the second embodiment of a control part of a ballast circuit according to the invention shown in FIG. 3 differs from the first embodiment of FIG. 2 in that it further comprises a power control loop for controlling a power of the ballast circuit to a reference power value Pₛₑₜ. The additional power control loop can be applied in the same way to the circuit shown in FIG. 1.

The additional power control loop comprises means (not shown) for measuring the mains voltage Vₘ, low pass filters 20 and 22 to filter the mains current measurement signal iₘ and the mains voltage measurement signal Vₘ respectively, a multiplier 24 for multiplying output signals of said filters 20, 22, a third subtractor 26 for subtracting the multiplication result from multiplier 26 from (compare to) the reference power value Pₛₑₜ to provide a third error signal, and a third control circuit 28 which receives the third error signal and which is connected to the reference waveform signal generator 10 to control the amplitude of the reference waveform signal dependent on the third error signal. The third control circuit may be of an integrating (I) or a proportional-integrating (PI) type. The output of multiplier 24 represents a value for the actual power of the ballast circuit. If it exceeds the reference power value Pₛₑₜ the third control circuit will control the reference waveform generator to decrease the amplitude of the reference waveform signal. As a result the first error signal at the output of the first subtractor 8 decreases, the high frequency decreases and the impedance of the ballast circuit to the main source increases, the mains current and its representation iₘ decrease, and the third error signal will decrease and so on until the third error signal approaches zero.

It is observed that in the diagrams some filters may be added, such as a high pass filter at the output of inverter 2, in fact at the output of the measurement means for measuring the mains current.

As can be seen in FIG. 3 the power control loop fits nicely to the mains current waveform loop shown in FIGS. 1 and 2. The relatively slow power control loop will not interfere with the relatively fast mains current waveform loop. In fact, the power control loop as described and shown in FIG. 3, in combination with the control loop for the mains current waveform, which is synchronized with the mains voltage, guarantees that control of power is carried out for substantially real power only and not for reactive power, with the reactive power being less useful to reflect and to control operation of the lamp.

It is observed that different methods can be applied to provide a value which represents the power. For example, the light emission by the lamp could be measured to provide such value.

Although not shown in the drawings it must be observed that each of the circuits shown in FIGS. 1 to 3 may operate in different ways in terms of a value of ignition frequency and normal frequency, that is after ignition of the lamp.

According to a first type of operation, a first nominal switching frequency of the inverter of each of said circuits is about a factor three smaller than a resonance frequency of the circuit as a whole. The ignition frequency is about three times said switching frequency. From a zero crossing of the low frequency mains cycle the first controller 6 will control VCO 4 to increase and then back to the first nominal switching frequency until arrival at zero crossing of the low frequency mains cycle.

According to a second type of operation, a second nominal switching frequency of the inverter of each of said circuits is about identical to a resonance frequency of the circuit as a whole. Under ignition conditions the ignition frequency is almost identical to said second nominal switching frequency. From a zero crossing of the low frequency mains cycle the first controller 6 will control VCO 4 to decrease and then back to the second nominal switching frequency until arrival at the next zero crossing of the low frequency mains cycle.

Said second type of operation has several advantages compared to the first type of operation. With the second type of operation the reference waveform supplied by generator 10 is better followed, resulting in a smaller THD. The lamp performance or lamp behavior will be better, resulting in an improved and more efficient operation of the circuit as a whole. Losses will be less. For example, assuming a 600 W system, losses will be reduced from 25 W to 20 W, that is an improvement of 20%.

To further improve the operation of the circuit it is preferred to add a third harmonic of the mains frequency to the reference waveform signal. Said third harmonic may have, for example, an amplitude of 15% of a base reference waveform signal used in the embodiments described before. This will result in a certain amount of third harmonic in the mains current as well, making a waveform of the mains current less than perfect sinusoidal and it will therefore increase the amount of lamp current near each zero-crossing of the mains voltage. The addition of little third harmonic has a positive effect on the lamp performance or behavior. The lamp current is decreased and therewith a VHF current decreases, which is beneficial to the circuit efficiency.

1. A method for supplying a gas discharge lamp from a main source of a substantial sinusoidal low frequency mains voltage, comprising: rectifying the mains voltage to provide a rectified voltage;
generating an inverter control signal of a high frequency;
modulating the frequency of the inverter control signal by a modulating signal to provide a modulated inverter control signal;
inverting the rectified voltage by the modulated inverter control signal to an inverter output voltage having the frequency of the modulated inverter control signal;
supplying the inverter output voltage to the lamp through a tank circuit;
characterized by,
measuring a current which is representative for a current supplied by the main source to provide a current measurement signal (iₘ);
generating a reference waveform signal with a frequency of and being synchronized with a supply voltage which corresponds to the measured current;
comparing the reference waveform signal and the current measurement signal to provide a first error signal; and
using the first error signal as the modulating signal, such that the error signal is minimized.

2. Method according to a claim 1, characterized in that the comparison step is made between the reference waveform signal and a sum of the current measurement signal and a phase shift error signal, which is obtained as a result from a comparison between a reference minimum phase value (φₘᵢₙ) and a phase difference which is detected between the inverter output voltage (V_{b}) and a current (i_{L}) through an inductor of the tank circuit.

3. Method according to claim 1, characterized in that a power representative signal, which is representative for a power supplied to the lamp, is determined, the power representative signal is compared with a reference power value to provide a power error signal, and the amplitude of the reference waveform signal is changed dependent on the power error signal, such that the power error signal is minimized.

4. Method according to claim 2, characterized in that, a supply voltage is measured, which is representative for a voltage supplied to the lamp and which corresponds to the measured current, to provide a supply voltage measurement signal (Vₘ), and the supply voltage measurement signal is multiplied by the current measurement signal (iₘ) to provide the power representative signal.

5. Method according to 1, characterized in that, a nominal frequency representing a frequency of the modulated inverter at a zero crossing of a mains voltage control signal is about identical to a resonance frequency of a circuit comprising the lamp and the tank circuit.

6. Method according to claim 1, characterized in that, the reference waveform signal comprises a small amount of third harmonic of a fundamental of the reference waveform signal.

7. Method according to claim 6, characterized in that the third harmonic of the reference waveform signal has an amplitude which is in a range of 10% to 20% of the amplitude of the fundamental of the reference waveform signal.

8. A ballast circuit for a gas discharge lamp, comprising:
input terminals, which are to be connected to a main source of a substantial sinusoidal low frequency mains voltage;
a rectifier circuit for receiving and rectifying the mains voltage to provide a rectified voltage;
a first generator (4), which is a voltage to frequency controlled generator, for providing a substantial rectangular high frequency inverter control signal, a control input of the first generator receiving a modulating signal which modulates the frequency of the inverter control signal to provide a modulated inverter control signal;
an inverter (2), which comprises switches, which are arranged to switch the rectified voltage and to output the switched rectified voltage as an inverter output voltage, the inverter being controlled by the modulated inverter control signal to control the frequency of the inverter output voltage to the frequency of the modulated inverter control signal;
a tank circuit, which is connected to the inverter and to the lamp to supply the inverter output voltage to the lamp;
characterized by
a first control loop which comprises:
a first measuring circuit for measuring a current which is representative for an input current supplied by the main source to provide a current measurement signal (iₘ);
a second generator (10) for generating a reference waveform signal with a frequency of and being synchronized with a supply voltage which corresponds to the measured current
a first subtractor (8) for subtracting the current measurement signal from the reference waveform signal to provide a first error signal; and
a first control circuit (6) which is arranged for receiving the first error signal and for providing the modulating signal;
whereby the first control loop is arranged to minimize the first error signal.

9. Ballast circuit according to claim 8, characterized in that the first control loop further comprises:
a phase detector (12) for detecting a phase difference between a current (i_{L}) through an inductor of the tank circuit and the inverter output voltage (V_{b});
a second subtractor (14) for subtracting the phase difference from a reference minimum phase difference (φₘᵢₙ) to provide a second error signal;
a second control circuit (16) which is arranged to receive the second error signal and to provide a phase dependent signal;
an adder (18) for adding the current measurement signal and the phase dependent signal to provide a substitute signal for the current measurement signal supplied to the first subtractor (8).

10. Ballast circuit according to claim 8, characterized by a second control loop, which comprises:
a first low pass filter (20), which receives the current measurement signal (iₘ);
a second measuring circuit for measuring a supply voltage which corresponds to the measured current to provide a voltage measurement signal (Vₘ);
a second low pass filter (22) for receiving the voltage measurement signal (Vₘ);
a multiplier (24) for receiving and multiplying output signals from the first and second low pass filters and to provide a power representative signal, which is representative for a power supplied to the lamp,
a third subtractor (26) for subtracting the power representative signal from a reference power value to provide a third error signal;
a third control circuit (28) which is arranged to receive the third error signal and to control the second generator (10) to change the amplitude of the reference waveform signal such that the third error signal is minimized.

11. Ballast circuit according to claim 8, characterized in that, the first generator is set to generate the inverter control signal with a nominal frequency representing a frequency of the modulated inverter at a zero-crossing of a mains voltage control signal, with the nominal frequency being about identical to a resonance frequency of a circuit comprising the lamp and the tank circuit.

12. Ballast circuit according to claim 8, characterized in that, the second generator generates the reference waveform signal such as to comprise in addition to its fundamental a small amount of third harmonic of the fundamental.

13. Ballast circuit according to claim 12, characterized in that the third harmonic of the reference waveform signal has an amplitude which is in a range of 10% to 20% of the amplitude of the fundamental of the reference waveform signal.
